(19) United States
(12) Patent Application Publication
(10) Pub. No.: US 2008/0261541 A1
(43) Pub. Date: Oct. 23, 2008

(54) Method and Device for Amplifying an Amplitude and Phase Modulated Electric Signal

(75) Inventor: Andreas Langer, Unterschleissheim-Lohhof (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Seimens Aktiengesellschaft, Munchen (DE)

(21) Appl. No.: 11/569,841

(22) PCT Filed: Jan. 4, 2006
(86) PCT No.: PCT/EP2006/050030

§ 371 Date: Nov. 30, 2006

(30) Foreign Application Priority Data
Jan. 12, 2005 (DE) 102005001496.8

(51) Int. Cl. H04B 1/02

(52) U.S. Cl. 455/102

(57) ABSTRACT

The aim of the invention is to suppress interference caused by a mismatch of the power amplifier of a polar-loop transmitter. To achieve this, the crest factor of the output signal from the power amplifier is measured during operation to detect the state of the mismatch and to identify the modification of the transfer characteristic curve of the power amplifier. The crest factor that have been determined are compared with a target value and if the crest factor deviates from the target value, the bandwidth or the amplification of the amplitude closed loop is adapted accordingly., The transmitter can thus regulate the non-linear distortion that occur as a result of the mismatch. Said measures improve the linear behavior or degree of efficiency of the power amplifier.

### FIELD OF TECHNOLOGY

The present disclosure is generally directed to a method and system for amplifying an amplitude and phase modulated signal in a polar loop transmitter.

### BACKGROUND

To increase the data rate for transmission via a mobile radio connection, modulation methods are recently being applied which influence both the amplitude and the phase relationship of the signal to be sent. Examples of this are variants of the GSM standard (global standard for mobile communication), in particular EDGE (Enhanced data rate for GSM Evolution). In order to avoid errors in the transmission of a signal that is both amplitude- and phase-modulated, the send unit generating the signal, and in particular its power amplifier, should have as linear a behavior as possible. Highly linear power amplifiers which satisfy the requirements are available in principle, but are more complex in construction and consequently dearer to manufacture.

The linearity of a transmitter used in modem mobile radio systems can be improved by the use of the so-called polar loop concept. In a polar loop transmitter based on this concept, two closed loops (amplitude closed loop/AM loop and phase-locked loop/PM loop) are used to modulate the amplitude separately from the phase on the carrier signal (see, for example, WO 03/005564 or WO 02/47249), both of which are incorporated by reference herein. The splitting of the amplitude-and phase-modulated signal into an exclusively amplitude-modulated and an exclusively phase-modulated component increases the bandwidth of the two separate signals. The bandwidth of the closed loops should therefore be selected to be as large as possible, in order to minimize the linear distortions of the two separate signals as a result of the low-pass effect of the respective closed loop. A large bandwidth of the AM loop does reduce linear distortions, but at the same time increases the noise in the receiver band (RX band) of an EDGE transceiver.

On the other hand, the bandwidth of the AM closed loop changes for a mismatch of the power amplifier, while the bandwidth of the PM loop usually remains constant in spite of a mismatch. In addition, the saturation power of the power amplifier falls. This can cause the amplifier to be driven into the non-linear area of the characteristic curve, and intermodulation products can arise. The related distortions of the output signal can mean that the system requirements for spectral purity of the signal are no longer met.

### SUMMARY

The present disclosure described in exemplary embodiments a method and system for largely suppressing interference effects generated by a mismatch of the power amplifier of a polar-loop transmitter.

Under the present disclosure, requirements regarding the necessary back-off of the power amplifier of a polar-loop transmitter can be considerably reduced. This is accompanied by improving the efficiency of the power amplifier, and correspondingly extending the maximum operating time of the mobile phone equipped with such a transmitter. Because of the low power dissipation of the power amplifier, its temperature also rises noticeably less during operation. In addition, the adaptive adjustment of the bandwidth of the AM closed loop ensures optimal noise behavior (as a consequence of the low bandwidth of the AM closed loop) and in the case of mismatch, as linear as possible behavior of the overall transmission facility.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates an exemplary crest factor, the linear output power and the output power of the amplifying unit of a polar loop transmitter dependent on the input power;

FIG. 2 illustrates an exemplary schematic structure of a polar-loop transmitter according to one embodiment.

### DETAILED DESCRIPTION

As previously mentioned, the saturation power of a amplifier unit of a polar-loop transmitter falls as a result of a mismatch. The back-off is thereby reduced, which leads to nonlinear distortions if the envelope is driven into the nonlinear area of the amplifier characteristic. Since the status of the mismatch is not detected in known transmitters, and furthermore the change of the characteristic curve as a consequence of a mismatch is unknown, it is suggested that a mismatch, or the resulting compression of the amplifier characteristic, should be detected by evaluation of the peak-to-average ratio, known as the crest factor, of the demodulated HF output signal and the accompanying interference effects.

The output signal y(t) of the amplifier unit is a nonlinear function of the input signal x(t) fed to the amplifier unit. The nonlinear transformation causes the statistical properties of the input signal x(t) to change, and hence also the crest factor CF. Assuming the transmission function of the amplifier unit is described by the following simple polynomial representation, the values a and c denoting constants and s(t) the complex envelope:

y(t)=ax(t)−cx³(t)

where x(t)=Re{s(t)e^{jωt}}, (Re{}:=Operator for real part);

The complex envelope s(t) here depends, according to the relation

s²(t)=I²(t)+Q²(t)

on the two baseband signals I(t) and Q(t). The crest factor CFₓ of the input signal x(t) is defined as

$${CF}_{x} = \frac{Max [ x ( t ) ]}{{σ}_{x}}$$

where σ²x(t)=E(x²(t)) (E{}:=Operator of the expected value).

If the crest factor CF_{y} of the output signal y(t) as a result of the nonlinear transformation is calculated, this gives:

$${CF}_{y} = {CF}_{x} \frac{1 \frac{c}{a} {σ}_{x}^{2} {CF}_{x}^{2}}{1 \frac{c}{a} {σ}_{x}^{2}} ,$$

where

$${CF}_{y} = \frac{Max [ y ( t ) ]}{{σ}_{y}}$$

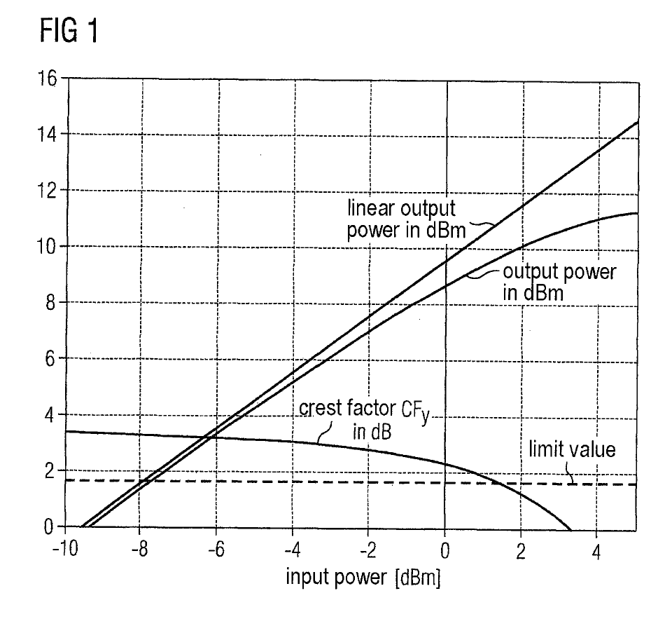

Under the named assumptions (approximate representation of the transmission function of the amplifier unit by a simple polynomial and not, as necessary, by a Volterra series), the crest factor depends only on the ratio c/a, which in turn is a measure for the 1 dB compression point of the amplifier characteristic. In FIG. 1 the crest factor CF_{y} and the output power of the amplifier unit are shown as a function of the input power for the parameter values a=3, c=0.3 und CFₓ=3.5 dB.

As can be seen at once from FIG. 1, the deviation measured in dBm of the output power from a linear reference output power is greater as the crest factor CF_{y} measured in dB becomes smaller. If a limit value SW, e.g. SW=1.8 dB, is preset, the value of the crest factor CF_{y} should then not be smaller than the value of the preset limit value SW. The value of the crest factor CF_{y} can thus serve as a measure for the compression of the amplifier characteristic, its deviation from a comparison value representing the state “characteristic curve not compressed” being independent of the absolute output power. The crest factor CF_{y} is determined rather by the “curvature” of the characteristic for the instantaneous mean output power of the amplifier unit.

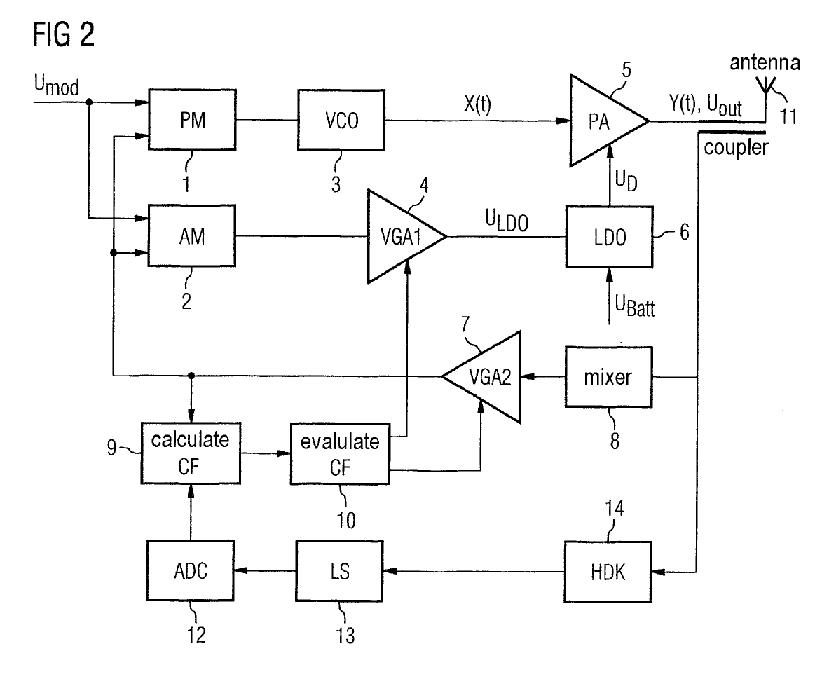

FIG. 2 represents the structure of a polar loop transmitter according to an exemplary embodiment. In this transmitter, the input signal U_{mod} to be amplified, which is both amplitude- and phase-modulated, is split into an amplitude-modulated component and a phase-modulated component, and these signal components are further processed in separate closed loops. The amplitude-modulated component here corresponds to the amount of the complex envelopes (see above), while the phase-modulated component corresponds to the phase of the complex envelopes. Separate closed loops exist for the two signal components, the amplitude closed loop (AM loop) consisting of an amplitude comparator 2, an intermediate repeater 4 and a battery voltage modulator (LDO 6), and the phase-locked loop (PM loop) comprising a phase comparator 1 and a voltage-controlled oscillator 3 which generates the input signal x(t) for the power amplifier 5. On the input side, the phase comparator 1 and the amplitude comparator 2 are each supplied both with the input signal U_{mod} as a reference/set value and also with the output signal Uₒᵤₜ of the power amplifier 5 as a comparison value, said output signal Uₒᵤₜ having been tapped with a coupler, possibly mixed down (mixer 8) to an intermediate or baseband frequency and then amplified (intermediate repeater—variable gain amplifier 7). The output signal of the phase comparator 1 readjusts the phase-modulated component of the output signal Uₒᵤₜ by means of the voltage-controlled oscillator 3 on the set value preset by the input signal U_{mod}. In the polar loop transmitter shown, the amplitude modulation is generated by variation of the supply voltage U_{D} of the power amplifier 5. Via the controllable battery voltage modulator 6 (control voltage U_{LDO}), the amplitude comparator 2 influences the supply voltage U_{D}=f(U_{LDO}, U_{BATT}) of the power amplifier 5 and hence the envelope of the output signal Uₒᵤₜ fed to the antenna 11, to the effect that the amplitude of the envelope of the output signal Uₒᵤₜ is an error-free image of the amplitude of the input signal U_{mod} present at one of the two inputs of the amplitude comparator 2. U_{D} is generated with the help of the voltage modulator 6 from a battery voltage U_{BATT}.

The linear area of the power amplifier 5 is characterized by a linear relationship between output signal Uₒᵤₜ and the control voltage U_{LDO}. This linear relationship exists so long as the control voltage U_{D} is sufficiently far from the battery voltage U_{Batt}. If the control voltage U_{D} approximates the battery voltage U_{Batt}, the transfer characteristic curve (Uₒᵤₜ dependent on U_{LDO}) of the power amplifier is compressed because of saturation effects in the LDO 6. The slope of the transfer characteristic curve is thereby reduced. This leads in the AM loop to a reduction of the loop bandwidth. In addition to the poorer guidance behavior of the control system, the reduction of the bandwidth also leads to further effects, which are typical for a polar loop transmitter and significantly influence the spectrum of the modulated transmission signal.

The splitting of the both amplitude-modulated and phase-modulated input signal U_{mod} into an amplitude-modulated and a phase-modulated component increases the bandwidth of the separate signal components. The bandwidth of the closed loops (AM loop and PM loop) must therefore be selected such that the linear distortions of the two part-signals as a result of the low-pass effect of the respective closed loop are minimal. For example, if the amplitude spectrum is too strongly filtered as a result of too low a bandwidth of the AM closed loop, this leads to a widened spectrum of the output signal Uₒᵤₜ. If the phase or amplitude spectrum is now linearly distorted (i.e. suppression of the higher-frequency parts of the amplitude spectrum), then the cancellation of the higher-frequency signal parts worsens in the overall spectrum, making the overall spectrum wider. From this can be derived the requirement to select the bandwidth of the closed loops as large as possible. However, as already explained above, this leads to an increased noise level in the receiver band (RX band).

Independently of the desired output power and the other environmental conditions, the bandwidth of the closed loop should preferably remain as constant as possible. The open-loop gain of the transmitter can be bordered with the intermediate repeater 4 (variable gain amplifier) in the forward branch. If the overall amplification of the AM loop is sufficiently great, this intermediate repeater 4 has no influence on the output power. The second intermediate repeater 7 (variable gain amplifier) in the reverse branch likewise goes into the overall amplification, but directly influences the output power Uₒᵤₜ. The greater the amplification of the feedback (mixer 8, amplifier 7), the smaller is the average output power.

As already explained above, the transfer characteristic curve is compressed if the output signal U_{LDO} of the intermediate repeater 4 approximates to the battery voltage U_{Batt}. If this occurs, the slope of the transfer characteristic curve is reduced, as is therefore also the open-loop amplification, which in turn means a reduction of the bandwidth of the AM closed loop. Since the GSM system requirements specify the saturation power of an EDGE transmitter and hence also of the power amplifier 5, the latter is operated with sufficient back-off. This back-off operation guarantees a sufficiently linear behavior of the amplifier up to the maximum possible power.

In spite of the previously mentioned back-off operation, however, undesired effects can occur with a mismatch of the transmit amplifier. A mismatch can be brought about by impedance changes, for example by a change in the distance between the mobile phone's antenna and the user's head. Such a mismatch has the effect that the slope of the transfer characteristic curve in the linear area and hence also the bandwidth of the AM closed loop will change. In addition, the saturation power of the transmitter amplifier falls. The lowering of the saturation power causes reduction of the back-off and hence of the distance to the nonlinear area of the transfer characteristic curve. If the transfer characteristic curve is driven into the nonlinear area as a result of the AM modulation, intermodulation products arise. These intermodulation products are compensated by the AM loop, provided the bandwidth of the AM control system is sufficiently large. However, since the latter cannot always be assumed, it is suggested that the crest factor CF_{y} of the amplifier output signal Uₒᵤₜ or y(t) should be used as the measure for the compression of the amplifier input signal x(t), and the bandwidth of the polar loop transmitter should be adjusted according to the deviation of the measured crest factor CF_{y} from a comparison value.

The crest factor CF_{y} can be measured for example by incoherent demodulation of the amplifier output signal Uₒᵤₜ or y(t) with the help of the device described in WO 03/096548 A2 which is incorporated by reference herein. As shown in FIG. 2, this device consists of an envelope demodulator (HDK) 14 supplied with the output signal of the coupler and measuring the instantaneous power or the average power (RMS power), a level converter (LS) 13, an analog-digital converter (ADC) 12 and a digital signal processing facility 9 used for calculating the crest factor CF_{y}.

If the measured crest factor CF_{y} falls below a threshold value specifying too high a compression, the amplification in the forward branch of the AM loop is increased. The necessary comparison of the crest factor CF_{y} with the threshold value is carried out in the means 10 arranged after the signal processing facility 9, the first output of this means 10 being connected to the control input of the intermediate repeater 4 while its second output is connected to the control input of the intermediate repeater 7. The increase of the forward amplification alters only the bandwidth of the AM loop, not the output power of the power amplifier 5. If the increase of the amplification (and thus of the bandwidth) is chosen according to the deviation of the measured crest factor CF_{y} from the threshold value, then the AM loop can compensate nonlinear distortions of the amplifier unit 5.

For too high a compression of the characteristic curve, the bandwidth of the AM loop must also be very highly enlarged, in order to include the intermodulation products of a higher order. However, this can impair the stability of the system. To avoid such stability problems, the bandwidth of the AM loop is first increased by activating the intermediate repeater 4, as already suggested. If the maximum increase of AM bandwidth or of the forward amplification is not sufficient to keep the then measured crest factor CF_{y} below the threshold value, it is advisable to increase the amplification in the reverse branch of the transmitter by activating the intermediate repeater 7, so that the back-off increases for unchanged output power and nonlinear distortions are reduced. At the same time, the amplification in the forward branch must naturally be adjusted accordingly, so that the bandwidth of the AM loop does not increase further.

Since the increase in the bandwidth may be important on stability grounds, it is further alternatively/additionally suggested that the characteristic of the AM loop should be influenced by alterations in a loop filter. Such a loop filter can be integrated or incorporated in the phase comparator 1. Thus for example the characteristic can be changed by activating or deactivating individual filter elements. The selection of the loop filter depends here on the crest factor. It is thereby possible with high bandwidths (and high forward amplification) to raise the phase margin, for example.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-9. (canceled)

10. A method for amplifying an amplitude- and phase-modulated signal in a polar loop transmitter, comprising the steps of:
separating a phase and an amplitude of the signal by means of a phase-locked loop and an amplitude closed loop, wherein the phase-locked loop generates an input signal for an amplifier unit and the amplitude closed loop generates a control voltage for the amplifier unit, and wherein the phase-locked loop and amplitude closed loop are controlled using a reference value;
determining at least one crest factor for the input signal;
comparing the crest factor with a set value; and
changing the amplification of the amplitude closed loop in one of a forward branch generating the control voltage and a reverse branch generating a reference value if the crest factor deviates from the set value.

11. A method for amplifying an amplitude- and phase-modulated signal in a polar loop transmitter, comprising the steps of:
separating a phase and an amplitude of the signal by means of a phase-locked loop and an amplitude closed loop, wherein the phase-locked loop generates an input signal for an amplifier unit and the amplitude closed loop generates a control voltage for the amplifier unit, and wherein the phase-locked loop and amplitude closed loop are controlled using a reference value;
determining at least one crest factor for the input signal;
comparing the crest factor with a set value;
changing the bandwidth of the amplitude closed loop by changing the amplification of a first amplifier in a forward branch that generates the control signal of the amplitude closed loop; and
changing the amplification of the amplitude closed loop by activation of a second amplifier in a reverse branch that generates the reference values of the phase and the amplitude of the amplitude closed loop.

12. A device for amplifying an amplitude- and phase-modulated signal, comprising:
an amplifying unit;
a phased-locked loop, coupled to an output side of the amplifying unit;
an amplitude closed loop coupled to the output side with a control input of the amplifier unit, wherein first inputs of the phased-locked loop and the amplitude closed loop each being supplied with a signal, and wherein second inputs of the phased-locked loop and the amplitude closed loop each being supplied with an extracted output signal of the amplifier unit;
first means for calculating the crest factor from the output signal of the amplifier unit; and
second means for comparing the crest factor with a set value and for changing one of the bandwidth and the amplification of the amplitude closed loop, depending on the deviation of the crest factor from the set value.

13. The device according to claim 12, further comprising a second amplifier that is coupled to (1) an input side via a coupler unit that is further coupled to the amplifier unit and (2) the output side with the second inputs of the phase-locked loop and the amplitude closed loop, wherein, on a control input of the second amplifier, a second output signal of the second means for changing the amplification of the amplitude closed loop is present.

14. The device according to claim 13, further comprising a first amplifier coupled on the input side with an amplitude comparator of the amplitude closed loop and on the output side with the amplifier unit, wherein, on a control input of the first amplifier, a first output signal of the second means for changing the amplification of the amplitude closed loop is present
